(19) United States
(12) Patent Application Publication
(10) Pub. No.: US 2025/0331051 A1
(43) Pub. Date: Oct. 23, 2025

(54) MANAGING CENTRAL UNIT FAILURE

(71) Applicant: Nokia Technologies Oy, Espoo (FI)

(72) Inventors: Subramanya CHANDRASHEKAR, Bangalore (IN); Guillaume DECARREAU, Munich (DE); Ethiraj ALWAR, Bangalore (IN); Ömer BULAKCI, Munich (DE); Raghuram Reddy KRISHNAMURTHY, Bangalore (IN); Andres ARJONA, Tokyo (JP)

(21) Appl. No.: 18/866,964

(22) PCT Filed: Jun. 19, 2023
(86) PCT No.: PCT/IB2023/056336

§ 371 Date: Nov. 18, 2024

(30) Foreign Application Priority Data
Jul. 13, 2022 (IN) 202241040161

(51) Int. Cl. H04W 76/20; H04L 43/0817; H04W 12/0431; H04W 72/21

(52) U.S. Cl. CPC H04W 76/20; H04L 43/0817; H04W 12/0431; H04W 72/21

(57) ABSTRACT

Various example embodiments relate to apparatuses and methods on user equipment state transition, such as for preventing a user equipment in a radio access network from transitioning to a radio resource control idle mode during failure of a central unit in a split radio access network architecture. A user equipment may receive from a distributed unit in the radio access network a central unit failure indication indicative of a failure of a first central unit in the radio access network associated with the distributed unit, and prevent the user equipment from transitioning into a radio resource control idle mode during the failure of the first central unit.

### TECHNICAL FIELD

Various example embodiments described herein generally relate to communication technologies, and more particularly, to apparatuses and methods on user equipment (UE) state transition, such as for preventing a UE from transitioning to a radio resource control (RRC) idle mode during failure of a central unit (CU) in a split radio access network (RAN) architecture.

### BACKGROUND

Certain abbreviations that may be found in the description and/or in the figures are herewith defined as follows:

| | |
|---|---|
| AMF | Access and Mobility Management Function |
| CN | Core Network |
| CP | Control Plane |
| CU | Central Unit |
| DL | Downlink |
| DU | Distributed Unit |
| E1 | Interface between CU-CP and CU-UP |
| F1 | Interface between CU and DU |
| F1-C | F1 Control plane |
| F1-U | F1 User plane |
| gNB | next generation Node-B |
| NG-RAN | Next Generation Radio Access Network |
| OAM | Operation Administration and Maintenance |
| PDCP | Packet Data Convergence Protocol |
| PDU | Protocol Data Unit |
| RLF | Radio Link Failure |
| RRC | Radio Resource Control |
| SDAP | Service Data Adaptation Protocol |
| SRB | Signaling Radio Bearer |
| UE | User Equipment |
| UL | Uplink |
| UP | User Plane |
| Xn | Interface between NG-RAN Nodes |

The next generation radio access network (NG-RAN) can have a split architecture where a next generation Node-B (gNB) includes a central unit (CU) and one or more distributed units (DUs). One gNB-DU is connected to only one gNB-CU, while one gNB-CU may be connected to one or more gNB-DUs. Each gNB-DU can support one or more cells. The split architecture allows for flexible hardware implementations adapted to diverse use cases and it can decrease the total cost of the network.

### SUMMARY

A brief summary of example embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a user equipment in a radio access network is provided. The user equipment may comprise at least one processor and at least one memory including computer program code. The at least one memory and the computer program code may be configured to, with the at least one processor, cause the user equipment at least to receive from a distributed unit in the radio access network a central unit failure indication indicative of a failure of a first central unit in the radio access network associated with the distributed unit, and prevent the user equipment from transitioning into a radio resource control idle mode during the failure of the first central unit.

In a second aspect, an example embodiment of a distributed unit in a radio access network is provided. The distributed unit may comprise at least one processor and at least one memory including computer program code. The at least one memory and the computer program code may be configured to, with the at least one processor, cause the distributed unit at least to start buffering radio resource control messages received from one or more user equipments in the radio access network when the distributed unit determines a failure of a first central unit in the radio access network which is configured in an active mode and associated with the distributed unit, and send to the one or more user equipments a central unit failure indication indicative of the failure of the first central unit.

In a third aspect, an example embodiment of a second central unit in a radio access network is provided. The second central unit may comprise at least one processor and at least one memory including computer program code. The at least one memory and the computer program code may be configured to, with the at least one processor, cause the second central unit at least to send to a distributed unit in the radio access network a standby central unit activation indication indicative of that the second central unit is to be activated to replace a first central unit in the radio access network. The first central unit is configured in an active mode and associated with the distribute unit.

Example embodiments of methods, apparatus and computer program products are also provided. Such example embodiments generally correspond to the above example embodiments, and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic block diagram illustrating a split architecture for a next generation Node-B.

FIG. 2 is a schematic message sequence chart illustrating loss of a radio resource control (RRC) message due to central unit failure.

FIG. 3 is a schematic message sequence chart illustrating a process according to an example embodiment of the present disclosure.

FIG. 4 is a schematic message sequence chart illustrating a process according to an example embodiment of the present disclosure.

FIG. 5 is a schematic flowchart illustrating a process according to an example embodiment of the present disclosure.

FIG. 6 is a schematic functional block diagram illustrating an apparatus according to an example embodiment of the present disclosure.

FIG. 7 is a schematic functional block diagram illustrating an apparatus according to an example embodiment of the present disclosure.

FIG. 8 is a schematic functional block diagram illustrating an apparatus according to an example embodiment of the present disclosure.

FIG. 9 is a schematic structural block diagram illustrating devices in a communication system in which example embodiments of the present disclosure can be implemented.

Throughout the drawings, same or similar reference numerals indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable devices or entities that can provide cells or coverage, through which terminal devices can access the network or receive services. The network device may be commonly referred to as a base transceiver station (BTS), a base station (BS), or some other suitable terminology. The term “base station” or “base transceiver station” used herein can represent a node B (NodeB or NB), an evolved node B (eNodeB or eNB), a next generation Node B (gNB), or a next generation enhanced Node B (ng-eNB). The base station may be embodied as a macro base station, a relay node, or a low power node such as a pico base station or a femto base station. The base station may also include or may be referred to as a RAN (radio access network) node, and may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any devices or entities that can wirelessly communicate with the network devices or with each other. Examples of the terminal device can include a mobile phone, a mobile terminal, a mobile station (MS), a subscriber station, a portable subscriber station, an access terminal, a personal digital assistant (PDA), a computer, a wearable device, an on-vehicle communication device, a machine type communication (MTC) device, a D2D communication device, a V2X communication device, a sensor and the like. The term “terminal device” can be used interchangeably with UE, a user terminal, a mobile terminal, a mobile station, or a wireless device.

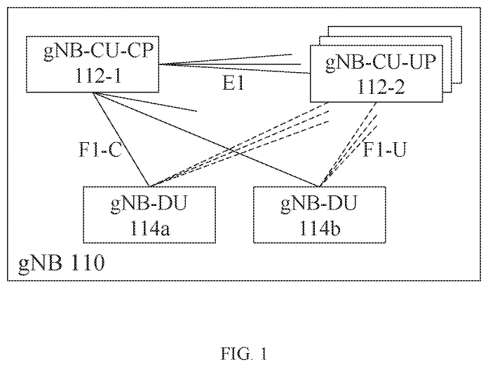

FIG. 1 illustrates a split architecture for a next generation Node-B (gNB) 110 with which some example embodiments of the present disclosure can be implemented. It would be appreciated that the gNB 110 is shown as an example, and the split architecture may also be applied to other base stations like eNB, ng-eNB, a beyond 5G base station, a 6G base station or a future base station.

As illustrated in FIG. 1, the gNB 110 may include a central unit (CU) 112 and one or more distributed units (DUs) 114 (two DUs 114a, 114b are shown as an example). The CU 112 may be separated into a control plane (CP) 112-1 and a number of user planes (UPs) 112-2. The gNB-CU-CP 112-1 is a logic node hosting a radio resource control (RRC) protocol and a control plane part of a packet data convergence protocol (PDCP) of the gNB 110, and the gNB-CU-UP 112-2 is a logic node hosting a user plane part of the PDCP protocol and a service data adaptation protocol (SDAP) of the gNB 110. The gNB-DU 114 is a logical node hosting radio link control (RLC), medium access control (MAC) and physical (PHY) layers of the gNB 110, and its operation is partly controlled by the gNB-CU 112. The gNB-CU-UP 112-2 is connected to the gNB-CU-CP 112-1 through an E1 interface, and the gNB-DU 114 is connected to the gNB-CU-CP 112-1 through an F1-C interface and to the gNB-CU-UP 112-2 through an F1-U interface. One gNB-CU-UP 112-2 is connected to only one gNB-CU-CP 112-1, and one gNB-DU 114 is connected to only one gNB-CU-CP 112-1. Each gNB-DU 114 may support one or multiple cells.

As seen from FIG. 1, since the gNB-CU-CP 112-1 controls multiple gNB-DUs 114 each supporting one or more cells, resiliency of the gNB-CU-CP 112-1 is crucial to provide service continuity and avoid downtime. If the gNB-CU-CP 112-1 fails, it would take a long time for establishment of a new F1 interface from scratch, which results in mass UE release and large downtime before the system is reinstated. 3GPP specification does not exclude that the gNB-DU 114 is connected to more than one gNB-CU 112 for resiliency, but it violates current cardinality rule for the RAN architecture and would lead to other problems. For example, radio resource management (RRM) by multiple gNB-CU-CPs 112-1 would cause fragmentation of resources and new co-ordination overhead between the gNB-CU-CPs.

Another option is to deploy a standby gNB-CU for geo-redundant resiliency, and the standby gNB-CU may be activated when the currently active gNB-CU-CP 112-1 fails. However, failure detection for the active gNB-CU and activation of the standby gNB-CU is also quite a longish process since it is often associated with long failure detection timers (to avoid false detection) and gNB-CU activation time. The standby gNB-CU activation also involves additional time as all the gNB-DUs served by the active gNB-CU need to be notified of the activation of the standby gNB-CU. The long duration between the failure of the active gNB-CU and activation completion of the standby gNB-CU may lead to radio link failure (RLF) of UEs for many reasons. For example, when a UE sends an uplink (UL) RRC message to the network but fails to receive any response from the network, the UE may declare RLF and transition to a radio resource control (RRC) idle mode. For another example, if a mobile UE fails to receive an RRC reconfiguration message when a handover command should have been received, the mobile UE would also declare RLF and transition to the RRC idle mode. On the network side, the active gNB-CU failure would cause a number of UEs to perform random access simultaneously after declaring the RLF, which is not a preferred scenario. The burst is impactful that resource allocation and processing becomes an incredibly complex task in the split gNB, especially when the split gNB includes a large number of DUs.

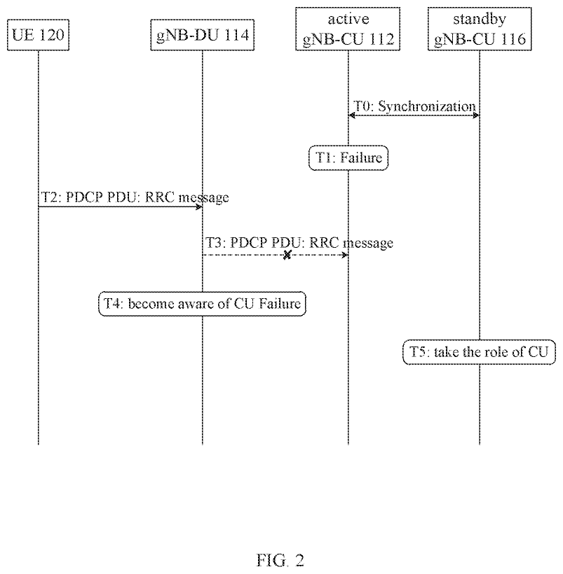

FIG. 2 is a schematic message sequence chart illustrating loss of an RRC message due to the gNB-CU failure. As illustrated in FIG. 2, a standby gNB-CU 116 is provided, in addition to the active gNB-CU 112. When the active gNB-CU 112 fails, the standby gNB-CU 116 would be activated and take over the role of the active gNB-CU 112.

At T0, the active gNB-CU 112 and the standby gNB-CU 116 may synchronize data with each other. For example, UE context information and operation administration and maintenance (OAM) configuration information may be synchronized between the active gNB-CU 112 and the standby gNB-CU 116.

At T1, the active gNB-CU 112 may encounter an unexpected failure, but the gNB-DU 114 associated with the gNB-CU 112 may not be immediately aware of the failure of the gNB-CU 112.

At T2, a UE 120 may transmit an UL signaling message for a signaling radio bearer (SRB) (i.e., an RRC message) via a PDCP control plane PDU to the gNB-DU 114.

At T3, since the gNB-DU 114 does not know the gNB-CU 112 has failed, the gNB-DU 114 may send the RRC message to the gNB-CU 112 as usual, but the failed gNB-CU 112 cannot receive the RRC message or synchronize the RRC message to the standby gNB-CU 116.

At T4, the gNB-DU 114 may become aware of the gNB-CU failure, e.g., by failure detection or notification received from the network.

At T5, the standby gNB-CU 116 may be activated and associated with the gNB-DU 114. Since then, the newly activated gNB-CU 116 takes over the role of the failed gNB-CU 112, and the gNB-DU 114 can send RRC messages to the gNB-CU 116.

However, the RRC message transmitted at T2 to the gNB-DU 114 is lost at the gNB-DU 114 as it is not delivered to the failed gNB-CU 112 nor to the standby gNB-CU 116. When the standby gNB-CU 116 becomes active, it will not receive the lost RRC message because the gNB-DU 114 does not perform retransmission of this message. It can happen that the RRC message from the UE 120 is an important message like an RRC reconfiguration complete message, and non-receipt of the RRC reconfiguration complete message could be treated as an RRC reconfiguration failure which would lead to an RRC reestablishment procedure. In addition, in the PDCP control layer at the gNB-CU-CP, as a hole in the PDCP reception sequence is created due to the RRC message loss, the reception entity has to wait until expiry of the t-Reordering timer, which increases the signaling processing time and degrades the efficiency of the network.

Hereinafter, example embodiments of apparatuses, methods and computer program products for preventing one or more UEs from transitioning into the RRC idle mode during failure of the active gNB-CU will be described in detail with reference to the accompanying drawings. In some example embodiments, the UEs may be configured to prevent from transitioning into the RRC idle mode by suspending transmission over a signaling radio bearer to the active gNB-CU and/or extending a timer if it is running or active, when the UEs are informed of the failure of the active gNB-CU. It can reduce non-effective operations at the UEs during the gNB-CU failure and save power consumption of the UEs. In addition, the burst of multiple UEs performing a random access procedure simultaneously after entering into the RRC idle mode can be avoided. In some example embodiments, the gNB-DU may buffer RRC messages received from UEs during the failure of the active gNB-CU and send the buffered RRC messages to the newly activated gNB-CU (i.e., the standby gNB-CU) when it is notified that the standby gNB-CU has been successfully activated. It can reduce or avoid uplink RRC message loss during the gNB-CU failure.

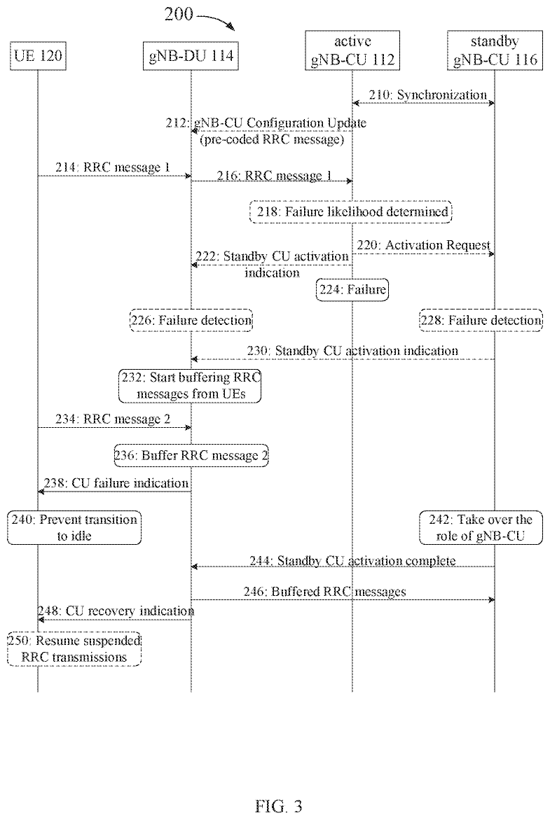

FIG. 3 is a schematic message sequence chart illustrating a process 200 according to an example embodiment of the present disclosure. The process 200 may be performed for example at the standby gNB-CU 116, the currently active gNB-CU 112, one or more gNB-DUs 114 associated with the active gNB-CU 112, and one or more UEs 120 served by each of the one or more gNB-DUs 114. For convenience of description, only one UE 120 and one gNB-DU 114 are discussed below. The UE 120, the gNB-DU 114, the active gNB-CU 112 and the standby gNB-CU 116 each may include a plurality of means, modules, components or elements for performing operations in the process 200, and the means, modules, components or elements may be implemented in various manners including but not limited to software, hardware, firmware, or any combination thereof. In the process 200 shown in FIG. 3, operations represented by dashed lines may be optionally or selectively performed in some example embodiments or be omitted in other example embodiments.

Referring to FIG. 3, at 210, the active gNB-CU 112 may synchronize data with the standby gNB-CU 116 which is provided as a backup for the active gNB-CU 112. If the active gNB-CU 112 fails, the standby gNB-CU 116 can be activated and take over the role of the active gNB-CU 112. The standby gNB-CU 116 can get synchronization data from the active gNB-CU 112 periodically so that it can replace the active gNB-CU 112 to serve the gNB-DUs 114 and the UEs 120 when the active gNB-CU 112 fails. For example, UE context information, operation administration and maintenance (OAM) configuration information and so forth may be synchronized between the active gNB-CU 112 and the standby gNB-CU 116.

At 212, the active gNB-CU 112 may send a pre-coded RRC message to the gNB-DU 114. The pre-coded RRC message may be sent via an F1 application protocol (F1AP) message for example a gNB-CU configuration update message to the gNB-DU 114. In other example embodiments, the pre-coded RRC message may be sent from an operation administration and maintenance (OAM) function (not shown) to the gNB-DU 114. The pre-coded RRC message may be encoded to be sent to the UEs 120 in case that the active gNB-CU 112 fails. For example, the pre-coded RRC message may include a CU failure indication to be sent to the UEs 120, which will be discussed in detail later.

At this point of time, it is assumed that the active gNB-CU 112 works well. For example, when the UE 120 sends an RRC message (e.g., RRC message 1) to the gNB-DU 114 at 214, the gNB-DU 114 can forward the RRC message to the active gNB-CU 112 successfully at 216. In some example embodiments, the active gNB-CU 112 may also synchronize the RRC message received at 216 to the standby gNB-CU 116.

At 218, the active gNB-CU 112 may determine there is a certain likelihood that the active gNB-CU 112 would be in failure. For example, the active gNB-CU 112 may determine the likelihood of failure by running an internal failure detection algorithm or based on a failure indication received from another network node or function, for example from the OAM function, e.g., via a management data analytics service (MDAS, also known as MDA MnS), or an open RAN (O-RAN) near-realtime RAN intelligent controller (RIC) or O-RAN non-realtime RIC or a RAN data analytics functions (DAF) or a core network data analytics function (DAF), e.g., network DAF (NWDAF).

At 220, in response to the failure likelihood, the active gNB-CU 112 may send a standby CU activation request to the standby gNB-CU 116 to trigger activation of the standby gNB-CU 116. Although not shown in FIG. 3, the standby gNB-CU 116 may respond to the active gNB-CU 112 with an acknowledge message to confirm receipt and acceptance of the activation request.

At 222, the active gNB-CU 112 may notify the gNB-DU 114 that the standby gNB-CU 116 would be activated to replace the active gNB-CU 112 by sending a standby CU activation indication to the gNB-DU 114. The standby CU activation indication may contain information (e.g., ID or address) of the active gNB-CU 112 and the standby gNB-CU 116, and information of a time duration after which the standby gNB-CU 116 will become active and take over the role of the gNB-CU 112. The time duration may be based on a recovery time estimation or a previous failure recovery time. In an example embodiment, the time duration may have a predefined value pre-configured at the gNB-DU 114 and it may be omitted in the standby CU activation indication. From the standby CU activation indication, the gNB-DU 114 can determine that the active gNB-CU 112 will fail soon, and the gNB-DU 114 may start buffering uplink RRC messages received from UEs to avoid RRC message loss due to the failure of the active gNB-CU 112.

In an example embodiment, the standby CU activation indication may further include an indication to extend timers for UE associated procedures and/or an indication to prevent from initiating a new procedure (e.g., an RAN3 (RAN Work Group 3) procedure) or retry of an existing procedure during the time duration. In response to the indications, the gNB-DU 114 may extend the timers for the UE associated procedures by adding a time duration to the timers or re-starting the timers. The time duration added to the timers may depend on the time duration of the failure indicated in the standby CU activation indication. The gNB-DU 114 may also prevent from initiating a new procedure (e.g., an RAN3 procedure) or retry of an existing procedure until the standby gNB-CU 116 is activated.

In an example embodiment, the standby CU activation indication may further include a list of RRC messages received at the active gNB-CU 112. In another example embodiment, the gNB-CU 112 may send the list of RRC messages received at the active gNB-CU 112 to the gNB-DU 114 via a separate RRC acknowledge message other than the standby CU activation indication. From the list of the received RRC messages, the gNB-DU 114 can be aware of which RRC messages have been successfully received at the active gNB-CU 112 and which RRC messages are not received at the active gNB-CU 112. It can help the gNB-DU 114 to check if an uplink RRC message is not delivered to the active gNB-CU 112. If an uplink RRC message is lost, the gNB-DU 114 may indicate the UE which has transmitted the lost RRC message to retransmit the RRC message.

In an example embodiment, the active gNB-CU 112 may also send the standby CU activation indication to an access and mobility management function (AMF), neighboring RAN nodes like neighboring base stations, a CU user plane associated with the gNB-DU 114, and other network nodes or functions having a direct interface with the active gNB-CU 112. For example, if the active gNB-CU 112 sends a handover request to a target gNB (not shown) in a handover procedure and then the gNB-CU 112 fails before it receives a handover acknowledge message from the target gNB, the target gNB would keep retrying at the stream control transmission protocol (SCTP) level to send the handover acknowledge message to the failed gNB-CU 112, even if there are no Xn level retries. In the example embodiment, the gNB-CU 112 may send the standby CU activation indication also to the target gNB before the gNB-CU 112 fails, and the target gNB would not initiate transmission or retransmission of the handover acknowledge message until the standby gNB-CU 116 is activated and replaces the active gNB-CU 112. The target gNB can re-start the timers relating to the gNB-CU 112 and not initiate any RAN3 procedure relating to the gNB-CU 112 during the standby CU activation. When the standby gNB-CU 116 is activated, the target gNB can send the handover acknowledge message to the newly activated gNB-CU 116.

In an example embodiment, the operation 222 may be omitted, and the standby gNB-CU 116 will send the standby CU activation indication to the gNB-DU 114 after it receives the standby CU activation request from the active gNB-CU 112, which will be discussed in detail below.

At 224, the active gNB-CU 112 may fail and the synchronization with the standby gNB-CU 116 may be interrupted. Here two scenarios may be considered. In a first scenario, the gNB-CU 112 may be aware of the upcoming failure. For example, a downtime may be scheduled for maintenance or upgrade of the network. Then the gNB-CU 112 can, before the failure, send the standby CU activation request to the standby gNB-CU 116 at 220 and send the standby CU activation indication to the gNB-DU 114 at 222. In a second scenario, the active gNB-CU 112 may be unaware of the upcoming failure. When the gNB-CU 112 fails, it may have not yet notified the standby gNB-CU 116 and the gNB-DU 114 of the failure at 220, 222. Then there would be a longer downtime before the standby gNB-CU 116 is activated because the standby gNB-CU 116 cannot be immediately aware of the failure of the active gNB-CU 112.

In the scenario of unexpected CU failure, the gNB-DU 114 may not receive the standby CU activation indication from the active gNB-CU 112 at 222. The gNB-DU 114 may detect whether the active gNB-CU 112 is in failure at 226. If the gNB-DU 114 retransmits an F1 application protocol (F1AP) message to the active gNB-CU 112 for maximal retransmission threshold times but it does not receive any response from the active gNB-CU 112, the gNB-DU 114 can determine that the active gNB-CU 112 is in failure and start buffering RRC messages received from the UEs.

Similarly, if the standby gNB-CU 116 does not receive the standby CU activation request from the active gNB-CU 112 at 220 e.g. in the scenario of unexpected CU failure, the standby gNB-CU 116 may detect whether the active gNB-CU 112 is in failure at 228. For example, if the standby gNB-CU 116 retransmits an Xn application protocol (XnAP) message to the active gNB-CU 112 for maximal retransmission threshold times but it does not receive any response from the active gNB-CU 112, the standby gNB-CU 116 can determine that the active gNB-CU 112 is in failure.

If the standby gNB-CU 116 determines the failure of the active gNB-CU 112 based on either the standby CU activation request received at 220 or the failure detection performed at 228, the standby gNB-CU 116 may send a standby CU activation indication to the gNB-DU 114 associated with the failed active gNB-CU 112 at 230. In another example embodiment, the standby gNB-CU 116 may send the standby CU activation indication to the gNB-DU 114 only when it determines the failure of the active gNB-CU 112 based on the failure detection performed at 228. When the standby gNB-CU 116 receives the standby CU activation request from the active gNB-CU 112 at 220, the standby gNB-CU 116 can suppose that the active gNB-CU 112 would send the standby CU activation indication to the gNB-DU 114 before the active gNB-CU 112 fails, and then the standby gNB-CU 116 does not need to send the standby CU activation indication to the gNB-DU 114 at 230.

As discussed above with respect to the operation 222, the standby CU activation indication sent at 230 may also include, in addition to the information (e.g., ID or address) of the active gNB-CU 112 and the standby gNB-CU 116, at least one of a time duration before the standby gNB-CU 116 is activated, an indication to extend timers for UE associated procedures, an indication to prevent from initiating a new procedure (e.g., an RAN3 procedure) or retry of an existing procedure during the indicated time duration, and a list of radio resource control messages that the standby gNB-CU 116 has received from the gNB-DU 114 through data synchronization with the active gNB-CU 112.

In some example embodiments, the standby gNB-CU 116 may also send the standby CU activation indication to an access and mobility management function (AMF), neighboring RAN nodes like base stations, a CU-UP associated with the gNB-DU 114, and other network nodes or functions having a direct interface with the active gNB-CU 112. The network nodes which receive the standby CU activation indication may re-start the timers relating to the gNB-CU 112 and not initiate any RAN3 procedure relating to the gNB-CU 112 before the standby gNB-CU 116 is activated.

As discussed above, the gNB-DU 114 can determine the failure of the active gNB-CU 112 based on the standby CU activation indication received from the active gNB-CU 112 at 222, the failure detection performed at 226 or the standby CU activation indication received from the standby gNB-CU 116 at 230. Upon determining the failure of the active gNB-CU 112, the gNB-DU 114 may immediately start buffering RRC messages received from the UE(s) 120 at 232. The gNB-DU 114 would not send the RRC messages received from the UE(s) 120 to the failed active gNB-CU 120. For example, if the gNB-DU 114 receives an RRC message (e.g., RRC message 2) from the UE 120 at 234, the gNB-DU 114 would buffer the received RRC message 2 at 236, but not forward the RRC message 2 to the failed active gNB-CU 120. Instead, when the standby gNB-CU 116 is activated and associated with the gNB-DU 114, the gNB-DU 114 will send the buffered RRC messages to the newly activated gNB-CU 116, which will be described in detail later.

The gNB-DU 114 may also send a CU failure indication to the UE(s) 120 at 238. The CU failure indication may include information (e.g., ID or address) of the failed gNB-CU 112, a time duration of the failure and cause of the failure. The time duration of the failure may be indicated from the network to the gNB-DU 114 e.g. in the operation 222, 230, estimated by the gNB-DU 114 from previous CU failure, or pre-configured at the gNB-DU 114. With the received time duration, the UE 120 may start a timer to monitor the CU failure period. The cause of the failure may include for example expected/planed downtime or unexpected failure, which may be determined at the gNB-DU 114 or indicated in the standby CU activation indication sent to the gNB-DU 114. For example, if the gNB-DU 114 determines the failure of the gNB-CU 112 based on the failure detection performed at 226, the gNB-DU 114 can infer that the failure cause is unexpected failure. In another example, the active gNB-CU 112 or the standby gNB-CU 116 can indicate the failure cause to the gNB-DU 114 in the standby CU activation indication sent to the gNB-DU 114.

In an example embodiment, the CU failure indication may further indicate whether the UE 120 can initiate a new RRC procedure or retry of an existing RRC procedure in uplink during the failure of the active gNB-CU 112. Since the gNB-DU 114 has limited buffer size to buffer RRC messages received from the served UEs, the gNB-DU 114 may indicate the served UEs not to initiate any new RRC procedure or retry of any existing RRC procedure during the failure of the active gNB-CU 112.

In an example embodiment, the CU failure indication may further include a list of RRC messages received from the UE 120 and buffered at the gNB-DU 114, from which the UE 120 can know that the buffered RRC messages have not yet been transmitted to the active gNB-CU and it can extend timers associated with the buffered RRC messages.

In an example embodiment, the CU failure indication may be sent via an RRC message which was pre-coded by the active gNB-CU 112 or the OAM function and sent in advance to the gNB-DU 114 at 212. In another example embodiment, the RRC message carrying the CU failure indication may be encoded by the gNB-DU 114 if it has the capability to encode an RRC message. The RRC message may be specially encoded for the UEs to receive it. In an example, a dedicated packet data convergence protocol (PDCP) sequence number (SN) may be used to identify the RRC message carrying the CU failure indication. Alternatively or additionally, a flag may be used to identify the RRC message carrying the CU failure indication when it is transmitted over a logical common control channel (CCCH). The RRC message may be encrypted with a cell specific common security key e.g. the message authentication code-integrity (MAC-i) which remains the same for UEs in a cell. It would be appreciated that the CU failure indication may also be sent via a medium access control (MAC) control element (MAC CE) or a physical layer (PHY) message.

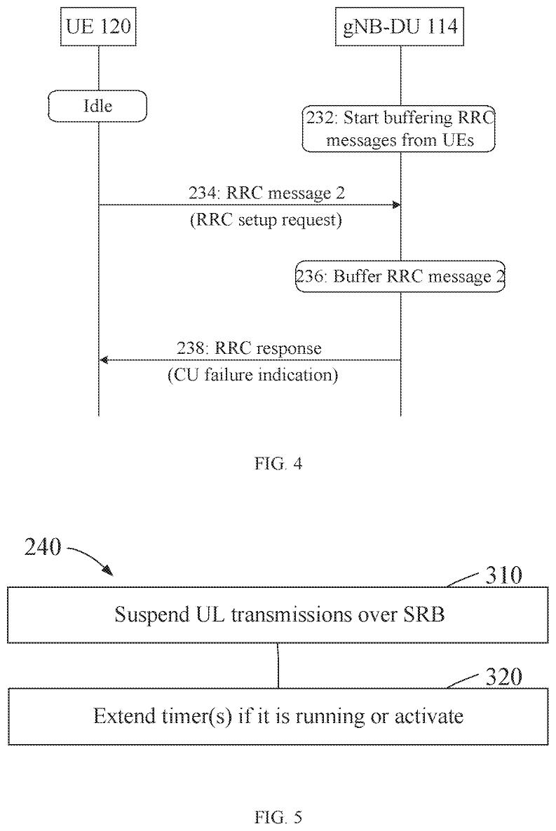

In the above discussion, the UE 120 may be in an RRC connected mode, and the gNB-DU 114 may proactively send the CU failure indication to the connected UEs including the UE 120. FIG. 4 illustrates another scenario where the UE 120 is already in the RRC idle mode. Referring to FIG. 4, after the gNB-DU 114 starts buffering RRC messages received from UEs at 232, the UE 120 may attempt to establish an RRC connection with the network by a random access procedure and send an RRC setup request message (as the RRC message 2) to the gNB-DU 114 at 234. The gNB-DU 114 may buffer the RRC setup request message at 236, and send back a pre-coded RRC response message including the CU failure indication to the UE 120 at 238. As mentioned above, the pre-coded RRC response message may be pre-coded by the active gNB-CU 112 or the OAM function and sent in advance to the gNB-DU 114 at 212. The CU failure indication carried in the pre-coded RRC response message may indicate to the UE 120, among others, cause and a time duration of the CU failure and instruct the UE 120 not to retry transmission of the RRC setup request message until the indicated time duration has passed.

Referring back to FIG. 3, at 240, the UE 120 may prevent itself from transitioning into the RRC idle mode during the failure of the active gNB-CU 112, in response to the CU failure indication received at 238. If the UE 120 is already in the RRC idle mode as discussed above with reference to FIG. 4, the UE 120 may remain in the random access procedure and prevent from returning/transitioning to the RRC idle mode and initiating the random access procedure again.

FIG. 5 illustrates some example operations that may be performed at the UE 120 to prevent from transitioning into the RRC idle mode. Referring to FIG. 5, at 310, the UE 120 may suspend one or more transmissions over signaling radio bearers (SRBs) (i.e., RRC messages) to the gNB-CU 112. At 320, the UE 120 may extend one or more timers if they are running or active. An active timer refers to a timer which has been registered and slated to tick a moment later. For example, the UE 120 may start a timer T304 when it receives an RRC connection reconfiguration message with mobility control information in a handover procedure. If the UE 120 fails to connect to the target cell and the timer T304 expires, the UE 120 will declare a radio link failure (RLF) and enter into the RRC idle mode. In the example embodiment, the UE 120 may extend the timer T304 to prevent from declaring the radio link failure and transitioning into the RRC idle mode. The UE 120 may extend the timer T304 by re-starting or pausing the timer or adding a time duration to the timer. The UE 120 may also extend other timers running before declaring the radio link failure or performing transmission or retransmission over the signaling radio bearers, i.e., timers of which the expiry would cause the UE 120 to declare the radio link failure or to transmit/retransmit an uplink RRC message. It would be appreciated that the operations 310, 320 are described as examples, and other operations may also be performed at the UE 120 to prevent the UE 120 from transitioning into the RRC idle mode.

Referring back to FIG. 3, at 242, the standby gNB-CU 116 may be successfully activated and associated with the gNB-DU 114. Since then, the newly activated gNB-CU 116 takes over the rule of the originally active gNB-CU 112, and the F1 interface between the gNB-CU 116 and the gNB-DU 114 become operational to serve the UEs.

At 244, the gNB-CU 116 may send a standby CU activation complete message to the gNB-DU 114, from which the gNB-DU 114 knows the gNB-CU 116 has been activated. In an example embodiment, a resiliency status indication message and relevant information elements (IEs) may be designed for use in the standby CU activation indication and standby CU activation complete messages. The resiliency status indication message may be defined as follows:

```
RESILIENCY STATUS INDICATION message
  •Direction: from gNB-CU to gNB-DU
  •UE associated message
  •IEs:
    ∘ CU Takeover (ENUMERATED (ongoing, complete, ...) optional
    ∘ UL SRB Buffering Command (ENUMERATED (start, stop, ...)
    Mandatory
    ∘ RRC Ack List (List of RRC messages) Optional
      ▪ RRC message 1
      ▪ ......
    ∘ ......
```

The IE “CU Takeover” indicates if the activation of the standby gNB-CU 116 is ongoing or already complete. The IE “UL SRB Buffering Command” indicates the gNB-DU 114 to start or stop buffering RRC messages received from the served UEs. The IE “RRC Ack List” includes indexes of uplink RRC messages that have been received at the active gNB-CU 112 or the standby gNB-CU 116. For example, in the standby CU activation indication sent in 222 or 230, the resiliency status indication message may be encoded as follows:

RESILIENCY STATUS INDICATION {
CU Takeover: ongoing;
UL SRB Buffering Command: start;
RRC Ack List (RRC message 1, ......)
}

In the standby CU activation complete message sent in 244, the resiliency status indication message may be encoded as follows:

RESILIENCY STATUS INDICATION {
CU Takeover: complete;
UL SRB Buffering Command: stop;
RRC Ack List (RRC message 1, ......)
}

At 246, the gNB-DU 114 may send the buffered RRC messages to the newly activated gNB-CU 116. The gNB-DU 114 may also perform other operations with the newly activated gNB-CU 116.

At 248, the gNB-DU 114 may send a CU recovery indication to the UE 120, in response to the standby CU activation complete message received from the newly activated gNB-CU 116. The CU recovery indication may include information of the newly activated gNB-CU 116. From receiving the CU recovery indication, the UE 120 can operate normally with the newly activated gNB-CU 116. Optionally, the CU recovery indication may further include information of one or more uplink RRC messages lost at the gNB-DU 114.

At 250, the UE 120 may resume the suspended transmissions over the signaling radio bearers towards the newly activated gNB-CU 116. The UE 120 may also retransmit the lost RRC messages indicated in the CU recovery indication to the newly activated gNB-CU 116.

In the above discussed process 200, the UEs are configured to prevent from transitioning into the RRC idle mode during failure of the active gNB-CU. It can reduce non-effective operations at the UEs during the gNB-CU failure and save power consumption of the UEs. In addition, the burst of a number of UEs performing the random access procedure simultaneously after entering into the RRC idle mode can be avoided. The gNB-DU can buffer RRC messages received from UEs during the active gNB-CU failure and send the buffered RRC messages to the newly activated gNB-CU after the CU failure duration. It can prevent uplink RRC message loss due to the gNB-CU failure.

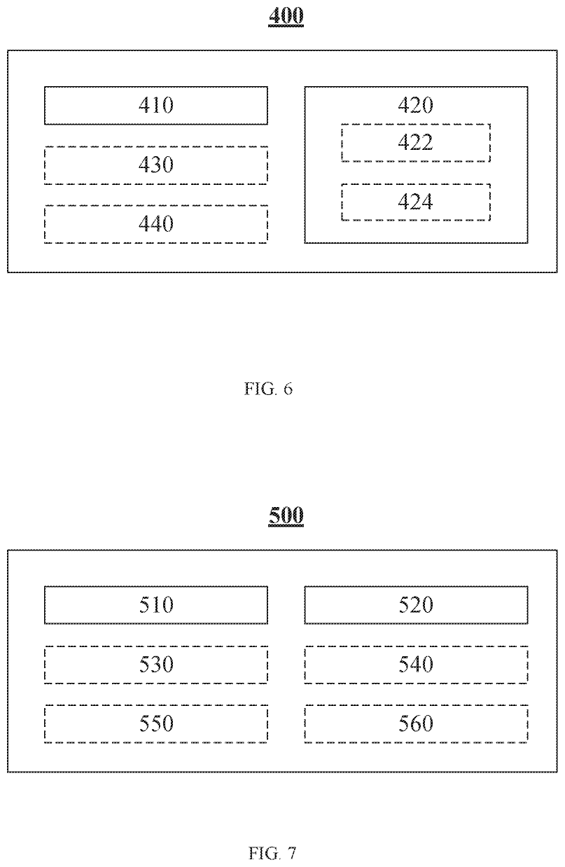

FIG. 6 is a schematic functional block diagram illustrating an apparatus 400 according to an example embodiment of the present disclosure. The apparatus 400 may be implemented at a terminal device like the UE 120 to perform operations relating to the UE 120 as discussed above. Since the operations relating to the UE 120 have been discussed in detail with reference to FIGS. 3-5, the blocks of the apparatus 400 will be described briefly here and details thereof may refer to the above description.

Referring to FIG. 6, the apparatus 400 may include a first means 410 for receiving from a gNB-DU 114 a central unit (CU) failure indication indicative of a failure of a first gNB-CU 112 which was configured in an active mode and associated with the gNB-DU 114 and a second means 420 for preventing the UE 120 from transitioning into a radio resource control (RRC) idle mode during the failure of the first gNB-CU 112.

In an example embodiment, the CU failure indication may include at least one of cause for the failure of the first gNB-CU 112, a time duration of the failure, an indicator indicative of whether or not a new RRC procedure in uplink and/or retry of an existing RRC procedure in uplink is permitted at the UE 120 during the failure of the first gNB-CU 112, an identifier or address of the first gNB-CU 112, and a list of RRC messages sent from the UE 120 buffered at the gNB-DU 114.

In an example embodiment, the CU failure indication may be received in an RRC message, a medium access control (MAC) control element (MAC CE) or a physical layer message.

In an example embodiment, the RRC message carrying the CU failure indication may be encrypted with a common security key that remains the same for UEs in a cell.

In an example embodiment, the RRC message carrying the CU failure indication may have a dedicated packet data convergence protocol (PDCP) sequence number (SN).

In an example embodiment, the RRC message carrying the CU failure indication may be sent with a flag over a common control channel.

In an example embodiment, the second means 420 may optionally include a first sub-means 422 for suspending transmission over a signaling radio bearer (SRB) to the first gNB-CU 112, and a second sub-means 424 for extending a timer if it is running or active.

In an example embodiment, the apparatus 400 may optionally include a third means 430 for receiving a CU recovery indication from the gNB-DU 114. The CU recovery indication may indicate that a second gNB-CU 116, which was configured in a standby mode, is activated and associated with the gNB-DU 114. The second means 420 may be configured to prevent the UE 120 from transitioning into the RRC idle mode until the CU recovery indication is received from the gNB-DU 114. In another example embodiment, the second means 420 may be configured to prevent the UE 120 from transitioning into the RRC idle mode for a predetermined time duration or for a time duration indicated in the CU failure indication received from the gNB-DU 114.

In an example embodiment, the apparatus 400 may optionally include a fourth means 440 for resuming the suspended transmission over the signaling radio bearer to the newly activated gNB-CU 116 in response to the CU recovery indication.

FIG. 7 is a schematic functional block diagram illustrating an apparatus 500 according to an example embodiment of the present disclosure. The apparatus 500 may be implemented at a network node like the gNB-DU 114 to perform operations relating to the gNB-DU 114 as discussed above. Since the operations relating to the gNB-DU 114 have been discussed in detail with reference to FIGS. 3-5, the blocks of the apparatus 500 will be described briefly here and details thereof may refer to the above description.

Referring to FIG. 7, the apparatus 500 may include a first means 510 for starting buffering radio resource control (RRC) messages received from one or more UEs 120 when the gNB-DU 114 determines a failure of a first gNB-CU 112 which was configured in an active mode and associated with the gNB-DU 114, and a second means 520 for sending to the UEs 120 a CU failure indication indicative of the failure of the first gNB-CU 112.

In an example embodiment, the gNB-DU 114 may determine the failure of the first gNB-CU 112 based on a standby CU activation indication received from the first gNB-CU 112 or a second gNB-CU 116 configured in a standby mode, or based on a failure detection performed at the gNB-DU 114 with respect to the first gNB-CU 112. The standby CU activation indication may be indicative of that the second gNB-CU 116 is to be activated and associated with the gNB-DU 114.

In an example embodiment, the standby CU activation indication may include at least one of a time duration before the second gNB-CU 116 is activated, a first indication to extend timers for procedures associated with the UEs 120, a second indication to prevent from initiating a new procedure or retry of an existing procedure during the time duration, and a list of RRC messages that have been received at the first gNB-CU 112 or the second gNB-CU 116.

In an example embodiment, the CU failure indication may be sent via a RRC message, an MAC CE or a physical layer message.

In an example embodiment, the RRC message carrying the CU failure indication may be encrypted with a common security key which remains the same for UEs in a cell.

In an example embodiment, the RRC message carrying the CU failure indication may have a dedicated packet data convergence protocol (PDCP) sequence number (SN).

In an example embodiment, the RRC message carrying the CU failure indication may be sent with a flag over a common control channel.

In an example embodiment, the CU failure indication may comprise at least one of cause for the failure of the first gNB-CU 112, a time duration of the failure, an indicator indicative of whether or not a new RRC procedure in uplink and/or retry of an existing RRC procedure in uplink is permitted at the UEs 120 during the failure of the first gNB-CU 112, an identifier or address of the first gNB-CU 112, and a list of RRC messages received from the UE 120 buffered at the gNB-DU 114.

In an example embodiment, the apparatus 500 may optionally include a third means 530 for receiving from the first gNB-CU 112 or an operation administration and maintenance (OAM) function an encoded RRC message comprising the CU failure indication before the failure of the first gNB-CU 112.

In an example embodiment, the CU failure indication may be encoded into an RRC message at the gNB-DU 114 before the CU failure indication is sent to the UEs 120.

In an example embodiment, the apparatus 500 may optionally include a fourth means 540 for receiving a standby CU activation complete message from the second gNB-CU 116. The standby CU activation complete message may indicate that the second gNB-CU 116, which was configured in the standby mode, is activated and associated with the gNB-DU 114.

In an example embodiment, the apparatus 500 may optionally include a fifth means 550 for sending the buffered RRC messages to the second gNB-CU 116 in response to the standby CU activation complete message.

In an example embodiment, the apparatus 500 may optionally include a sixth means 560 for transmitting to the UEs 120 a CU recovery indication in response to the standby CU activation complete message.

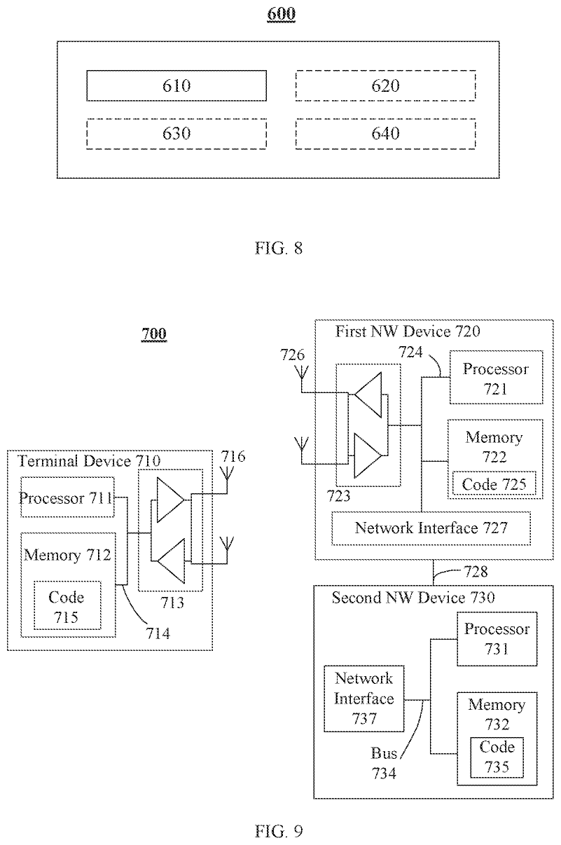

FIG. 8 is a schematic functional block diagram illustrating an apparatus 600 according to an example embodiment of the present disclosure. The apparatus 600 may be implemented at a network node like the standby gNB-CU 116 to perform operations relating to the standby gNB-CU 116 as discussed above. Since the operations relating to the standby gNB-CU 116 have been discussed in detail with reference to FIGS. 3-5, the blocks of the apparatus 600 will be described briefly here and details thereof may refer to the above description.

Referring to FIG. 8, the apparatus 600 may include a first means 610 for sending to a gNB-DU 114 a standby central unit (CU) activation indication indicative of that the standby gNB-CU 116 is to be activated to replace an active gNB-CU 112 associated with the gNB-DU 114. For convenience of description, the active gNB-CU 112 may be referred to as a first gNB-CU, and the standby gNB-CU 116 may also be referred to as a second gNB-CU.

In an example embodiment, the standby CU activation indication may include at least one of a time duration before the second gNB-CU 116 is activated, a first indication to extend timers for procedures associated with UEs served by the gNB-DU 114, a second indication to prevent from initiating a new procedure or retry of an existing procedure at the gNB-DU 114 during the time duration, and a list of RRC messages that have been received at the second gNB-CU 116 from the gNB-DU 114.

In an example embodiment, the standby CU activation indication may be sent also to an access and mobility management function (AMF), neighboring radio access network (RAN) nodes, a CU user plane associated with the gNB-DU 114, and other network nodes or functions having a direct interface with the first gNB-CU 112.

In an example embodiment, the apparatus 600 may optionally include a second means 620 for receiving from the first gNB-CU 112 or an operation administration and maintenance (OAM) function a standby CU activation request before the standby CU activation indication is sent to the gNB-DU 114.

In an example embodiment, the apparatus 600 may optionally include a third means 630 for sending to the gNB-DU 114 a standby CU activation complete message when the second gNB-CU 116 is activated and associated with the gNB-DU 114.

In an example embodiment, the apparatus 600 may optionally include a fourth means 640 for receiving from the gNB-DU 114 one or more uplink RRC messages buffered at the gNB-DU 114 before the second gNB-CU 116 is activated.

FIG. 9 is a schematic structural block diagram illustrating devices in a communication system 700 in which example embodiments of the present disclosure can be implemented. As shown in FIG. 9, the communication system 700 may comprise a terminal device 710 which may be implemented as the UE 120 discussed above, a first network device 720 which may be implemented as the gNB-DU 114 discussed above, a second network device 730 which may be implemented as the active gNB-CU 112 and/or the standby gNB-CU 116 discussed above.

Referring to FIG. 9, the terminal device 710 may comprise one or more processors 711, one or more memories 712 and one or more transceivers 713 interconnected through one or more buses 714. The one or more buses 714 may be address, data, or control buses, and may include any interconnection mechanism such as series of lines on a motherboard or integrated circuit, fiber, optics or other optical communication equipment, and the like. Each of the one or more transceivers 713 may comprise a receiver and a transmitter, which are connected to one or more antennas 716. The terminal device 710 may wirelessly communicate with the first network device 720 through the one or more antennas 716. The one or more memories 712 may include computer program code 715. The one or more memories 712 and the computer program code 715 may be configured to, when executed by the one or more processors 711, cause the terminal device 710 to perform operations and procedures relating to the UE 120 as described above.

The first network device 720 may comprise one or more processors 721, one or more memories 722, one or more transceivers 723 and one or more network interfaces 727 interconnected through one or more buses 724. The one or more buses 724 may be address, data, or control buses, and may include any interconnection mechanism such as a series of lines on a motherboard or integrated circuit, fiber, optics or other optical communication equipment, and the like. Each of the one or more transceivers 723 may comprise a receiver and a transmitter, which are connected to one or more antennas 726. The first network device 720 may operate as a distributed unit of a split base station and wirelessly communicate with the terminal device 710 through the one or more antennas 726. The one or more network interfaces 727 may provide wired and/or wireless communication links through which the first network device 720 may communicate with other network devices, entities, elements or functions. The first network device 720 may communicate with the second network device 730 via a link 728. The one or more memories 722 may include computer program code 725. The one or more memories 722 and the computer program code 725 may be configured to, when executed by the one or more processors 721, cause the first network device 720 to perform operations and procedures relating to the gNB-DU 114 as described above.

The second network device 730 may comprise one or more processors 731, one or more memories 732, and one or more network interfaces 737 interconnected through one or more buses 734. The one or more buses 734 may be address, data, or control buses, and may include any interconnection mechanism such as a series of lines on a motherboard or integrated circuit, fiber, optics or other optical communication equipment, and the like. The second network device 730 may operate as a central unit of a split base station and wired or wirelessly communicate with the first network device 720 through one or more links. The one or more network interfaces 737 may provide wired or wireless communication links through which the second network device 730 may communicate with other network devices, entities, elements or functions. The one or more memories 732 may include computer program code 735. The one or more memories 732 and the computer program code 735 may be configured to, when executed by the one or more processors 731, cause the second network device 730 to perform operations and procedures relating to the gNB-CU 112 and/or the gNB-CU 116 as described above.

The one or more processors 711, 721 and 731 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 711, 721 and 731 may be configured to control other elements of the network devices and operate in cooperation with them to implement the procedures discussed above.

The one or more memories 712, 722 and 732 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 712, 722 and 732 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide computer program code or instructions which, when executed by one or more processors, may cause a device or apparatus to perform the procedures described above. The computer program code for carrying out procedures of the exemplary embodiments may be written in any combination of one or more programming languages. The computer program code may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

Some exemplary embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. A user equipment, comprising:
at least one processor; and
at least one memory including computer program code, the at least one memory and the computer program code being configured to, with the at least one processor, cause the user equipment at least to:
receive from a distributed unit, a central unit failure indication indicative of a failure of a first central unit associated with the distributed unit; and
prevent the user equipment from transitioning into a radio resource control idle mode during the failure of the first central unit.

2. The user equipment of claim 1 wherein preventing the user equipment from transitioning into the radio resource control idle mode comprises at least one of:
suspending transmission over a signaling radio bearer to the first central unit; and
extending a timer if it is running or active.

3. The user equipment of claim 1 wherein the user equipment is prevented from transitioning into the radio resource control idle mode for a predetermined time duration, for a time duration indicated in the central unit failure indication, or until a central unit recovery indication is received at the user equipment, and
the central unit recovery indication is indicative of that a second central unit, which was configured in a standby mode, is activated and associated with the distributed unit.

4. The user equipment of claim 3 wherein the at least one memory and the computer program code are further configured to, with the at least one processor, cause the user equipment at least to:
resume the suspended transmission over the signaling radio bearer to the second central unit in response to the central unit recovery indication.

5. The user equipment of claim 1 wherein the central unit failure indication is carried in a radio resource control message, a medium access control control element or a physical layer message.

6. The user equipment of claim 5 wherein the radio resource control message carrying the central unit failure indication is encrypted with a common security key,
the radio resource control message carrying the central unit failure indication has a dedicated packet data convergence protocol sequence number, and/or
the radio resource control message carrying the central unit failure indication is sent with a flag over a common control channel.

7. The user equipment of claim 1 wherein the central unit failure indication comprises at least one of:
cause for the failure of the first central unit;
a time duration of the failure;
an indicator indicative of whether a new radio resource control procedure in uplink and/or retry of an existing radio resource control procedure in uplink is permitted during the failure of the first central unit or not;
an identifier or address of the first central unit; and
a list of radio resource control messages sent from the user equipment buffered at the distributed unit.

8. A distributed unit, comprising:
at least one processor; and
at least one memory including computer program code, the at least one memory and the computer program code being configured to, with the at least one processor, cause the distributed unit at least to:
start buffering radio resource control messages received from one or more user equipments when the distributed unit determines a failure of a first central unit, the first central unit being active and associated with the distributed unit; and
send to the one or more user equipments, a central unit failure indication indicative of the failure of the first central unit.

9. The distributed unit of claim 8 wherein the distributed unit determines the failure of the first central unit based on:
a standby central unit activation indication received from the first central unit or from a second central unit, the standby central unit activation indication being indicative of that the second central unit is to be activated and associated with the distributed unit; or
a failure detection performed at the distributed unit for the first central unit.

10. The distributed unit of claim 9 wherein the standby central unit activation indication received from the first central unit or the second central unit includes at least one of:
a time duration before the second central unit is activated;
a first indication to extend timers for procedures associated with the one or more user equipments;
a second indication to prevent from initiating a new procedure or retry of an existing procedure during the time duration; and
a list of radio resource control messages that have been received at the first central unit or the second central unit.

11. The distributed unit of claim 8 wherein the central unit failure indication is sent via a radio resource control message, a medium access control control element or a physical layer message.

12. The distributed unit of claim 11 wherein the radio resource control message carrying the central unit failure indication is encrypted with a common security key,
the radio resource control message carrying the central unit failure indication has a dedicated packet data convergence protocol sequence number, and/or
the radio resource control message carrying the central unit failure indication is sent with a flag over a common control channel.

13. The distributed unit of claim 8 wherein the central unit failure indication comprises at least one of:
cause for the failure of the first central unit;
a time duration of the failure;
an indicator indicative of whether a new radio resource control procedure in uplink and/or retry of an existing radio resource control procedure in uplink is permitted during the failure of the first central unit or not;
an identifier or address of the first central unit; and
a list of radio resource control messages received from the user equipment buffered at the distributed unit.

14. The distributed unit of claim 8 wherein the at least one memory and the computer program code are further configured to, with the at least one processor, cause the distributed unit at least to:
receive from the first central unit or an operation administration and maintenance function, an encoded radio resource control message comprising the central unit failure indication before the distributed unit determines the failure of the first central unit.

15. The distributed unit of claim 8 wherein the central unit failure indication is encoded into a radio resource control message at the distributed unit before it is sent to the one or more user equipments.

16. The distributed unit of claim 8 wherein the at least one memory and the computer program code are further configured to, with the at least one processor, cause the distributed unit at least to:
receive a standby central unit activation complete message from a second central unit, the standby central unit activation complete message being indicative of that the second central unit is activated and associated with the distributed unit; and
send the buffered radio resource control messages to the second central unit.

17. The distributed unit of claim 16 wherein the at least one memory and the computer program code are further configured to, with the at least one processor, cause the distributed unit at least to:
transmit to the one or more user equipments, a central unit recovery indication in response to receiving the standby central unit activation complete message from the second central unit.

18. A second central unit, comprising:
at least one processor; and
at least one memory including computer program code, the at least one memory and the computer program code being configured to, with the at least one processor, cause the second central unit at least to:
send to a distributed unit, a standby central unit activation indication indicative of that the second central unit is to be activated to replace a first central unit, the first central unit being active and associated with the distribute unit.

19. The second central unit of claim 18, wherein the standby central unit activation indication includes at least one of:
a time duration before the second central unit is activated;
a first indication to extend timers for procedures associated with user equipments served by the distributed unit;
a second indication to prevent from initiating a new procedure or retry of an existing procedure at the distributed unit during the time duration; and
a list of radio resource control messages that have been received at the second central unit from the distributed unit.

20. The second central unit of claim 18 wherein the standby central unit activation indication is further sent to an access and mobility management function, neighboring radio access network nodes, a central unit user plane associated with the distributed unit, and other network nodes or functions having a direct interface with the first central unit.

21. The second central unit of claim 18 wherein the at least one memory and the computer program code are further configured to, with the at least one processor, cause the second central unit at least to:
receive from the first central unit or an operation administration and maintenance function, a standby central unit activation request before sending the standby central unit activation indication to the distributed unit;
send to the distributed unit, a standby central unit activation complete message when the second central unit is activated and associated with the distributed unit; and
receive from the distributed unit, one or more uplink radio resource control messages buffered at the distributed unit before the second central unit is activated and associated with the distributed unit.

22. A method implemented at a user equipment, comprising:
receiving from a distributed unit, a central unit failure indication indicative of a failure of a first central unit associated with the distributed unit; and
preventing the user equipment from transitioning into a radio resource control idle mode during the failure of the first central unit.

23-48. (canceled)
